(19) United States
(12) Patent Application Publication
(10) Pub. No.: US 2002/0128941 A1
(43) Pub. Date: Sep. 12, 2002

(54) Techniques for generating and managing electronic investment contracts

(76) Inventors: Robert R. Champion, San Francisco, CA (US); Valere B. Costello, Sandy's MA (BM)

Correspondence Address: Steven R. Bartholomew, Esq., 41st Floor, 60 East 42nd Street, New York, NY, 10165, US

(21) Appl. No.: 09/802,026

(22) Filed: Mar. 8, 2001

(51) Int. Cl. G06F 17/60

(52) U.S. Cl. 705/36

(57) ABSTRACT

A computerized method for generating an electronic investment contract. The electronic investment contract provides enhanced flexibility through the use of investor-selectable allocation parameters and response parameters linked to one or more investment asset categories. More specifically, an investment identifier is used to uniquely specify a corresponding electronic investment contract. Each of one or more investment identifiers is associated with an investment amount and one or more asset category identifiers. The asset category identifier uniquely specifies an investment asset category, and it is associated with a corresponding allocation parameter and a corresponding response parameter. The allocation parameter specifies an allocation amount to be indexed to the corresponding asset category identifier, and the response parameter specifies a relationship between the allocation amount and any subsequent price and/or net worth changes in the corresponding investment asset category.

### FIELD OF THE INVENTION

The invention relates generally to electronic financial management systems and methods, and, more specifically, to computer-based techniques for generating and managing electronic investment contracts related to indexed investment vehicles.

### BACKGROUND OF THE INVENTION

In the past, many investors have employed managed portfolios as primary investment vehicles. An ever-popular investment vehicle is the mutual fund, which permits investors to readily participate in capital markets with a minimum of effort. Mutual funds are typically administered by professional money managers who take fees as a percentage of the net asset value of the fund over a given time period. These fees are then used to finance large research departments that sift through and select various investments for the funds. The management fee varies from fund to fund, but, as a general rule, it usually falls between 0.2% and 1.5% of the net asset value of the fund. From a legal standpoint, mutual funds represent an ownership cooperative of selected securities. Accordingly, the participating investors are charged with many of the legal responsibilities of owning securities, without the attendant control thereof. If the fund invests in the stock market, the investors are essentially bearing the diversifiable risk of positions in a limited number of stocks.

Despite the fact that mutual funds are managed by financial experts, it is an unfortunate practical reality that a significant percentage of these funds fail to outperform the general equity markets. Past studies indicate that a significant percentage of all managed funds were outperformed by the Standard and Poor's (S&P's) 500® Composite Stock Price Index. The S&P 500 Index is a relative valuation of the stocks of 500 large companies, most of which are listed and traded on the New York Stock Exchange, and is considered to be a general indicator of the performance of the US equity markets. The relatively poor performance of managed funds has generated substantial interest in investment products that track the overall performance of the equity markets while, at the same time, being unencumbered by asset research fees and high transaction costs. For example, indexed stock funds are presently available that invest in the stocks of the S&P 500 companies and, therefore, directly track the performance of the S&P 500 Index.

At the present time, investors are attempting to take a more active role in managing their wealth. Moreover, capital investment markets have experienced dramatic fluctuations in response to changing economic, political, and financial conditions. This has created a global investment environment characterized by rapidly changing inflationary expectations, unpredictable interest rates, volatile exchange rates, and a fully internationalized capital marketplace. Traditional investment vehicles, such as stocks, bonds, and mutual funds are being supplanted in part by newer, more flexible investment vehicles that provide investors with enhanced opportunities to actively manage their investments. These versatile products include “beta” funds and exchange-traded funds (ETFs).

A “beta” fund is a special type of mutual fund that is linked to one or more major market indices, such as the S&P 500. In Bermuda, the Bank of Bermuda presently offers beta funds referred to as their “All Points Index Funds”. In the U.S., other beta funds are offered by Rydex, ProFunds, and Potomac. These funds offer leveraged as well as inverse exposures to one or more major market indices. A significant degree of flexibility is provided, in that no limits are placed on switching. Liability is limited, and leverage is provided at low cost. Over the past several years, beta funds have enjoyed explosive growth. For example, Rydex has expanded from $600 million (1995) to $9 billion (2000). ProFunds has increased from $400 million (1998) to $3 billion (2000).

Exchange-traded funds (ETFs) are index-based trusts listed on a major international stock exchange, such as the American Stock Exchange. Each of these trusts aggregates “baskets” of stocks of a representative equity index. Illustrative ETFs include SPDRs, DIAMONDS, QQQs, and WEBs. In general, ETFs permit intra-day trading, and provide the investor with a precise, desired level of risk exposure. As was the case with beta funds, ETFs have also enjoyed explosive growth. The aggregate growth of SPDRs, DIAMONDS, QQQs and WEBs has increased from $1 billion in 1994 to $60 billion in 2000.

Despite the recent popularity of beta funds and ETFs, these investment vehicles are not sufficiently flexible for many investors. With respect to beta funds, it is currently not possible to trade more than twice a day. Moreover, it is impossible or cumbersome for the investor to obtain a precise or desired level of risk exposure. Although ETFs provide precise levels of risk exposure and permit investors to engage in intra-day trading, they also expose the investor who sells short to unlimited liability. Furthermore, ETFs do not provide a high degree of leveraging at low cost. Accordingly, there is a need for an investment vehicle that provides an enhanced degree of flexibility relative to presently existing alternatives.

### SUMMARY AND OBJECTS OF THE INVENTION

It is an object of the invention to provide an electronically generated investment instrument that offers enhanced flexibility relative to presently existing alternatives.

It is also an object of the invention to provide an Internet-based, Intranet-based, and/or wireless system for managing and tracking the electronically generated investment instrument.

It is yet another object of the invention to provide, for a given investment instrument, an Internet-accessible mechanism for accurately adjusting and monitoring a selection of assets and the level of risk for each selected asset.

It is still another object of the invention to provide an Internet-accessible graphical user interface for receiving investor requests related to the electronically generated investment instrument, such as requests that involve any of asset selection, risk adjustment, investments, and/or redemptions.

It is yet another object of the invention to respond to investor requests such that the position of an investor's electronically generated investment instrument reflects the asset category diversification and associated level of risk within each asset category as desired by that investor.

The above and other objects of the invention are realized in the form of a computerized method for generating an electronic investment contract. The electronic investment contract provides enhanced flexibility through the use of investor-selectable allocation parameters and response parameters linked to one or more investment asset categories. More specifically, an investment identifier is used to uniquely specify a corresponding electronic investment contract. Each of one or more investment identifiers is associated with an investment amount and one or more asset category identifiers. The asset category identifier uniquely specifies an investment asset category, and is associated with a corresponding allocation parameter and a corresponding response parameter. The allocation parameter specifies an allocation amount to be indexed to the corresponding asset category identifier, and the response parameter specifies a relationship between the allocation amount and any subsequent price and/or relative valuation changes in, and/or any net worth changes relating to, the corresponding investment asset category. This relationship could be positive (long) or negative (short), and also could be one-to-one (non-leveraged) or with an absolute value greater than one-to-one (leveraged).

Pursuant to a further embodiment of the invention, the electronic investment contracts are managed by means of an Internet-accessible graphical user interface. The user interface provides a mechanism by which each asset category of one or more electronic investment contracts can be established at a selected level of risk. Risk may be specified in terms of an amount and/or percentage of money, which is then associated with a multiplicative factor to be applied to the market return of that asset category. Market exposure is determined by multiplying the aforementioned amount and/or percentage of money by the aforementioned multiplicative factor. The graphical user interface mechanism is coupled to a data processing mechanism that calculates an aggregate market exposure in a given asset category among a plurality of electronic investment contracts. Based upon this aggregate exposure, the data processing mechanism determines an offsetting “required hedge” position, via possible implementation of purchases or sales of individual securities, futures contracts in selected market indices, and other financial transactions related to that asset category. Electronic investment contract funds may also be invested in a mix of income-bearing instruments, such as U.S. Treasury Notes. As investors change their desired market exposures and/or levels of risk, or make investments and redemptions, the data processing mechanism automatically adjusts the parameters related to the corresponding electronic investment contracts, and automatically initiates any required hedging transactions in the relevant asset category. Based upon market prices, the exposure and net asset value of each electronic investment contract is updated. Optionally, an administration fee may be charged.

According to a still further embodiment of the invention, the graphical user interface provides a conditional order-entry mechanism adapted to accept conditional (If-Then) orders from an investor. The graphical user interface then forwards the conditional If-Then order to the data processing mechanism. The data processing mechanism responds to conditional If-Then investor requests such that, only upon the occurrence of the condition specified by the investor, one or more asset category identifiers, allocation parameters, and/or response parameters pertaining to the investor's electronic investment contract are added or modified. In this manner, the net position of the electronic investment contract reflects an investor's specified asset exposure and level of risk.

### BRIEF DESCRIPTION OF THE DRAWINGS

The foregoing features of the present invention may be more fully understood from the following detailed discussion of specific illustrative embodiments thereof, presented below in conjunction with the accompanying drawings, in which:

FIG. 1 is a hardware block diagram setting forth an illustrative implementation for a system designed to generate and manage electronic investment contracts.

FIG. 2 is a diagram setting forth an illustrative data structure for an investment identifier lookup table.

FIG. 3 is a diagram setting forth an illustrative data structure for an electronic investment contract records database.

FIGS. 4A and 4B together constitute a diagram setting forth an illustrative data structure for a Country-Asset Category-Exchange Table.

FIG. 5 is a diagram setting forth an illustrative data structure for a set of investor-defined If-Then templates.

FIGS. 6A and 6B are information flow diagrams setting forth various types of data that may be received by, and/or transmitted to, the Investment Contract Web Site of FIG. 1.

FIGS. 7A-7C are information flow diagrams setting forth data flow for the processes of accepting applications, receiving investment requests, and approving initial investments.

FIGS. 8A-8B together comprise a flowchart setting forth an operational sequence for generating and managing electronic investment contracts.

FIG. 9 is a flowchart setting forth a high-level operational sequence for managing electronic investment contracts.

FIG. 10 is a screen-capture diagram showing an illustrative graphical user interface provided by the system of FIG. 1.

### DETAILED DESCRIPTION OF THE PREFERRED EMBODIMENTS

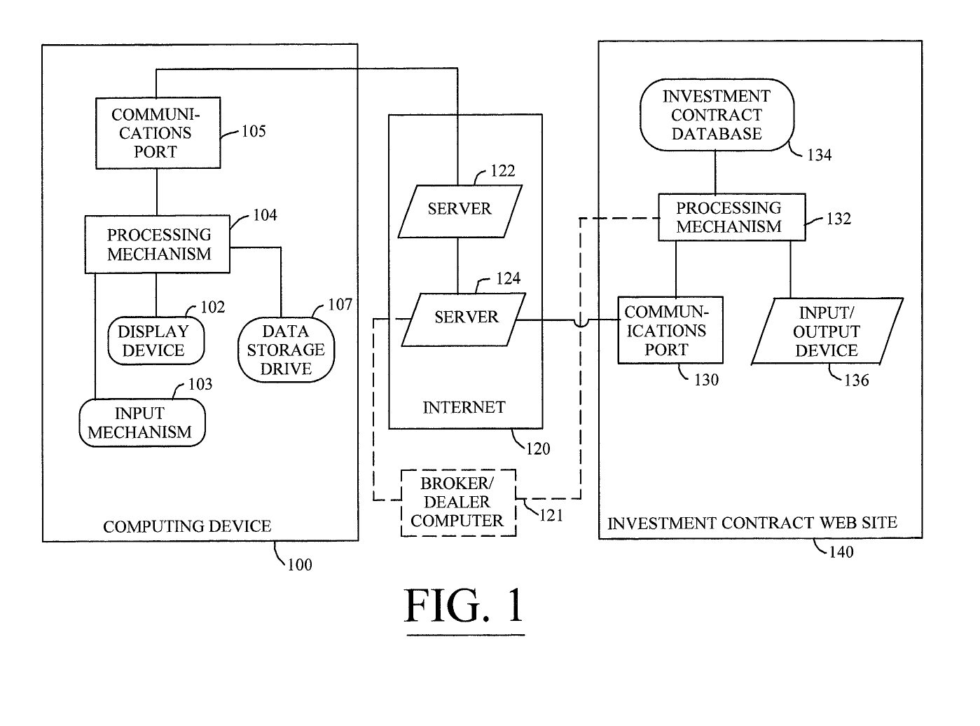

In overview, the invention provides computerized methods for generating electronic investment contracts. Refer to FIG. 1, which is a hardware block diagram setting forth an illustrative implementation for a system equipped to generate and manage these electronic investment contracts. An investment contract Web site 140 includes an electronic investment contract database 134 coupled to a processing mechanism 132. Investment contract database 134 can be implemented using any device adapted for the storage of information, whether by electronic, mechanical, magnetic, optical, or other means, or various combinations thereof. For example, one or more computer hard drives could be used to implement investment contract database 134, as could a read/write CD-ROM device, a magnetic tape backup unit, and/or electronic RAM (random access memory).

Processing mechanism 132 represents any electronic device equipped to process data and to access the investment contract database 134. A personal computer, a mainframe computer, and/or a microprocessor could be employed for processing mechanism 132. Investment contract database 134 and processing mechanism 132 could, but need not, represent discrete elements. For example, if a personal computer is used to implement processing mechanism 132, the hard drive of this personal computer could function as investment contract database 134.

Processing mechanism 132 is coupled to a communications port 130. Communications port 130 represents a port that conveys electronic communications between processing mechanism 132 and Internet 120. An input/output device 136 is coupled to processing mechanism 132. This input/output device 136 represents one or more devices capable of sending information to, and/or receiving information from, processing mechanism 132. Examples of suitable input/output devices are computer keyboards, display screens, floppy disk drives, optical disk drives, tape backup units, computer mice, tracking balls, smart card readers, magnetic strip readers, bar code readers, and others.

Communications port 130 is coupled to Internet 120. This coupling could, but need not, be implemented using modems, conventional twisted-pair telephone lines, Ethernet connections, ISDN lines, fiber-optic cable, coaxial cable, and/or any of various wireless devices such as spread-spectrum transceivers or wireless modems. Internet 120 may be conceptualized as containing a network of linked servers, such as servers 122 and 124. Optionally, a broker/dealer computer 121 can interface with processing mechanism 132 of investment contract Web site 140, and/or with server 124 directly over Internet 120.

Server 122 of Internet 120 is coupled to a communications port 105 of a computing device 100. Computing device 100 represents a device by which an individual such as a user, manager, customer, investor, and/or administrator interacts with the investment contract Web site 140. Computing device 100 includes a data storage drive 107 coupled to a processing mechanism 104. Data storage drive 107 can be implemented using any device adapted for the storage of information, whether by electronic, mechanical, magnetic, optical, or other means, or various combinations thereof. For example, one or more computer hard drives could be used to implement data storage drive 107, as could a read/write CD-ROM device, a magnetic tape backup unit, and/or electronic RAM (random access memory).

Processing mechanism 104 represents any electronic device equipped to process data and to access data storage drive 107. A personal computer, a laptop computer, a mainframe computer, and/or a microprocessor could be employed for processing mechanism 104. Data storage drive 107 and processing mechanism 104 could, but need not, represent discrete elements. For example, if a personal computer is used to implement processing mechanism 104, the hard drive of this personal computer could function as data storage drive 107.

Processing mechanism 104 is coupled to a communications port 105. Communications port 105 represents a port that conveys electronic communications between processing mechanism 104 and Internet 120. An input mechanism 103 and a display device 102 are coupled to processing mechanism 104. Input mechanism 103 represents one or more devices capable of sending information to processing mechanism 104, and display device 102 represents one or more devices capable of receiving and displaying information from processing mechanism 104. Input mechanism 103 and display device 102 could, but need not, be separate devices. Examples of suitable input devices for input mechanism 103 are computer keyboards, touch screens, floppy disk drives, optical disk drives, tape backup units, computer mice, tracking balls, smart card readers, magnetic strip readers, bar code readers, and others. Examples of suitable output devices for display device 102 are computer display screens, voice synthesizers, LCD displays, LED displays, audio annunciators, and others.

Communications port 105 is coupled to the Internet 120. This coupling could, but need not, be implemented using modems, conventional twisted-pair telephone lines, Ethernet connections, ISDN lines, fiber-optic cable, coaxial cable, and/or any of various wireless devices such as spread-spectrum transceivers or wireless modems.

It is to be understood that the hardware configuration of FIG. 1 is presented only for purposes of illustration. Clearly, the skilled artisan may envision any number of modifications, alternatives, additions, and/or simplifications to the hardware scheme of FIG. 1. All such variations are intended to be within the spirit and scope of the invention.

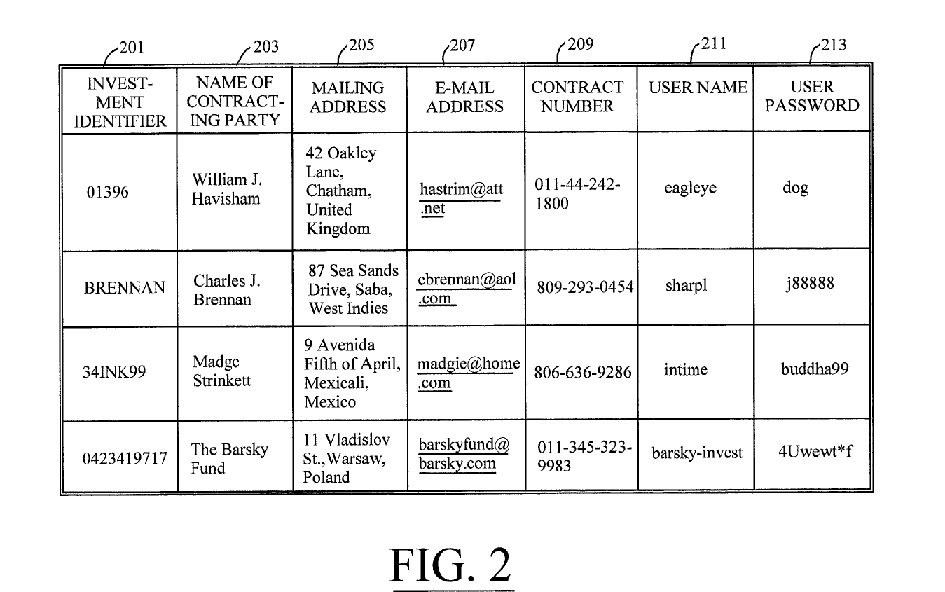

Refer now to FIG. 2, which is a diagram setting forth an illustrative data structure for an investment identifier lookup table. An investment identifier, specified in investment identifier 201 field, is used to uniquely specify a corresponding electronic investment contract. In practice, a sequence of numbers (01396), alphanumeric codes (341NK99), alphabetic characters (WJKL), combinations thereof (94WJKL), and/or personal names (Brennan) could be used as investment identifiers. Each of a plurality of investment identifiers is associated with the name of a contracting party, stored in a “name of contracting party” 203 field. The name of the contracting party can be a personal name, such as Madge Strinkett, or it can indicate the name of another investing entity, such as the Barsky Fund. The mailing address of the contracting party is stored in a mailing address 205 field, their e-mail address is stored in an e-mail address 207 field, and their contact telephone number is stored in a contact number 209 field. Each contracting party may be assigned, or may select and/or specify: (i) a user name that is stored in user name 211 field, and (ii) a user password that is stored in user password 213 field.

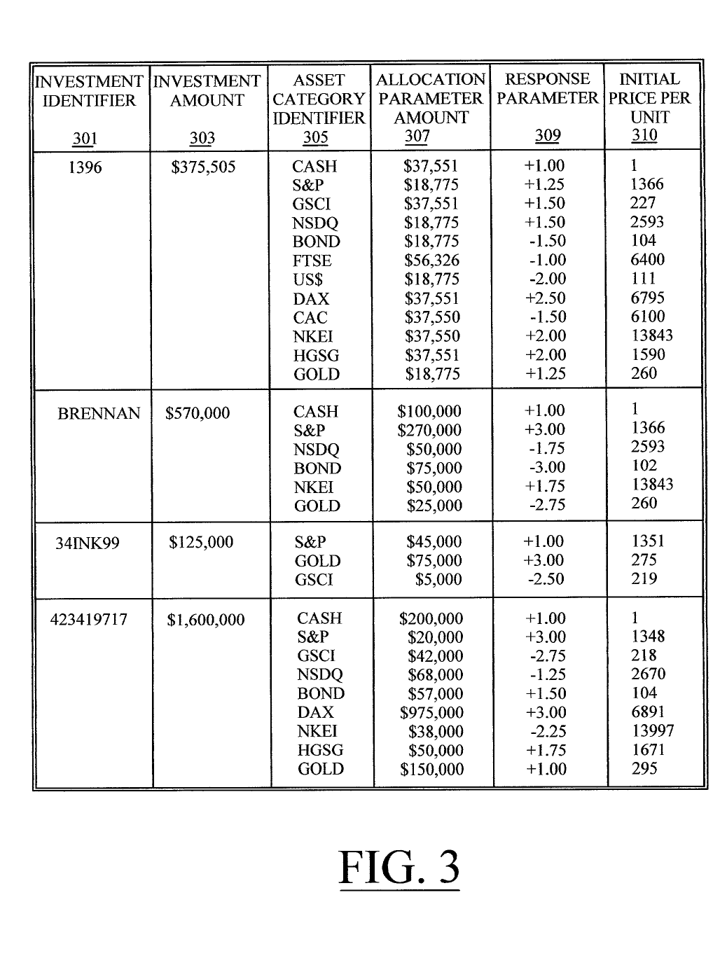

FIG. 3 is a diagram setting forth an illustrative data structure for an electronic investment contract records database. Each of one or more investment identifiers (stored in Investment Identifier 301 field) is associated with an investment amount (stored in Investment Amount 303 field) and one or more asset category identifiers (stored in Asset Category Identifier 305 field). Electronic investment contracts are financial instruments that provide investors with enhanced flexibility through the use of investor-selectable allocation parameters and/or amounts (stored in Allocation Parameter/Amount 307 field), as well as investor-selectable response parameters (stored in Response Parameter 309 field). These allocation and response parameters are linked to one or more investor-selectable investment asset categories stored in Asset Category Identifier 305 field. In other words, the asset category identifier uniquely specifies an investment asset category, and it is associated with a corresponding allocation parameter and a corresponding response parameter. The allocation parameter specifies an allocation amount to be indexed to the corresponding asset category identifier, and the response parameter specifies a relationship between the allocation amount and any subsequent price and/or relative valuation changes in, and/or net worth changes relating to, the corresponding investment asset category.

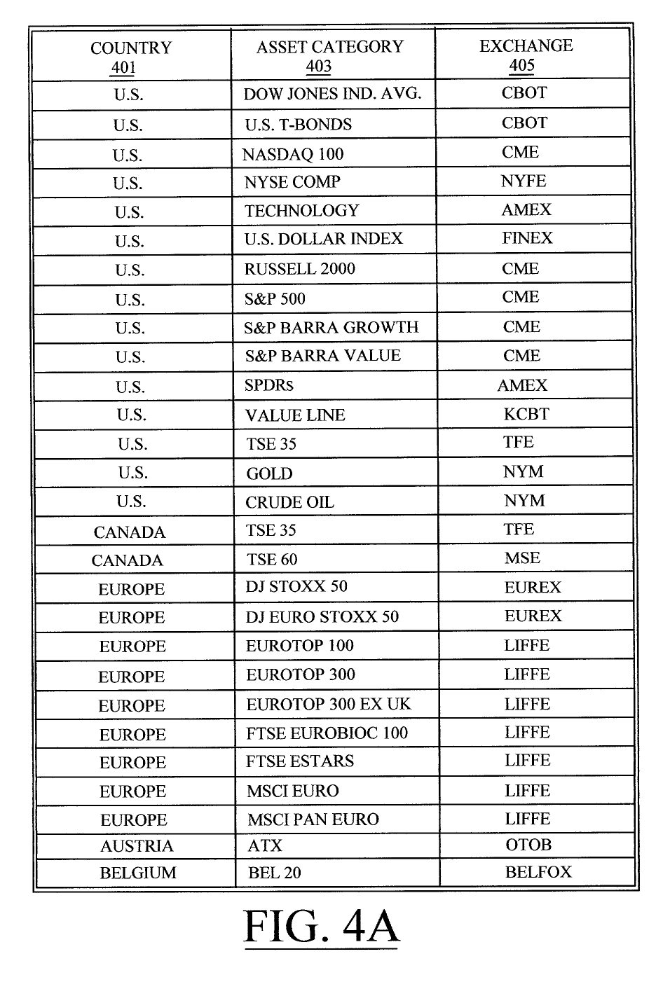

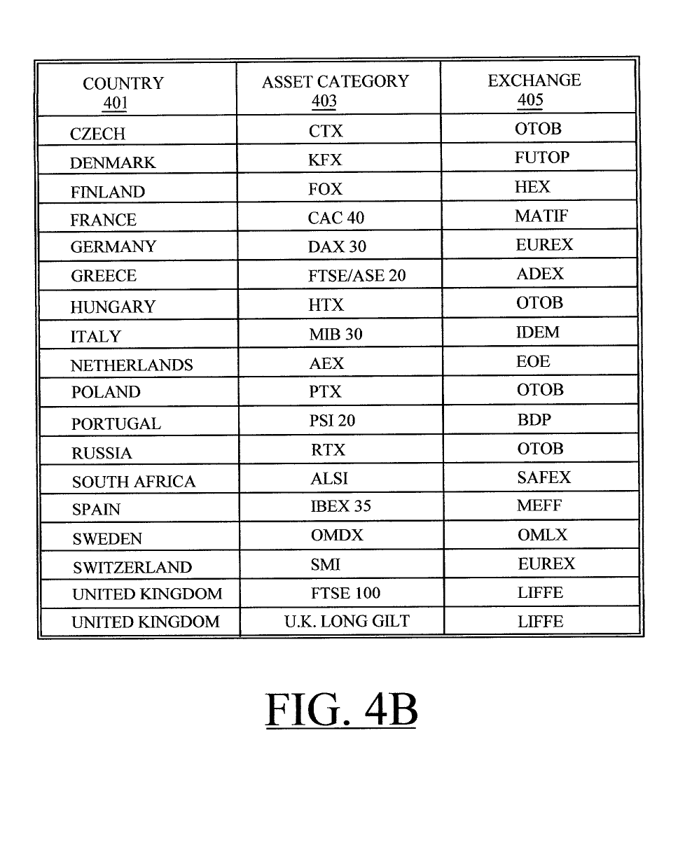

FIGS. 4A and 4B together constitute a diagram setting forth an illustrative data structure for a Country-Asset Category-Exchange Table. This Table stores information related to the Asset Category Identifiers previously described in conjunction with FIG. 3. More specifically, each of a plurality of financial and commodity asset categories (stored in Asset Category 403 field) is associated with a corresponding country (stored in Country 401 field) and a corresponding stock, bond, or commodity futures contract exchange (stored in Exchange 405 field). For example, the Dow Jones Industrial Average is an Asset Category that is associated with a corresponding futures contract on the Chicago Board of Trade in the United States. Similarly, “Technology” is associated with an ETF (Exchange-Traded Fund) on the American Stock Exchange (AMEX).

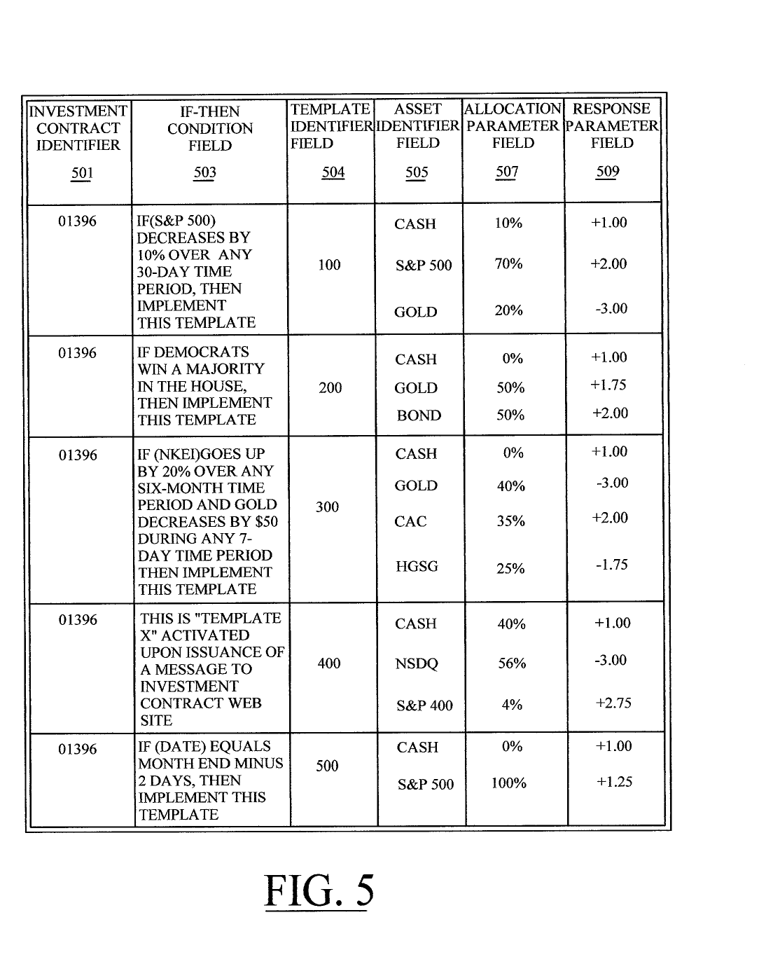

FIG. 5 is a diagram setting forth an illustrative data structure for a set of investor-defined If-Then templates. More specifically, note that the investment contract Web site of FIG. 1 may be equipped to provide a conditional order entry mechanism for accepting conditional If-Then orders from an investor. The conditional If-Then order is forwarded to the data processing mechanism upon receipt. The data processing mechanism responds to conditional If-Then investor requests such that, only upon the occurrence of the condition specified by the investor, one or more asset category identifiers, allocation parameters, and/or response parameters pertaining to the investor's electronic investment contract are added or modified. In this manner, the net position of the electronic investment contract reflects the asset category exposure and level of risk desired by the investor.

The If-Then templates of FIG. 5 include an Investment Contract Identifier 501 Field that associates a specified electronic investment contract with one or more corresponding If-Then conditions, asset identifiers, allocation parameters, and response parameters. The If-Then conditions, stored in If-Then Condition 503 Field, are user-specified and/or user-selected. The If-Then condition can include any of a number of logical conditions, such as “Implement this template if: (a) the Nikkei Index increases by 20% over any six-month period, and (b) Gold decreases by $50 during any 7-day period”. Information from any of various databases may be inputted, scanned, accessed, and/or reviewed to determine the presence or absence of any of these conditions. Template identifiers, each uniquely identifying a specific template, are stored in Template Identifier 504 field, asset identifiers are stored in Asset Identifier 505 field, allocation parameters are stored in Allocation Parameter 507 field, and response parameters are stored in Response Parameter 509 field. Optionally, a template could be activated by the investor accessing the investment contract website (140, FIG. 1) via the Internet, or by the investor placing a telephone call over the PSTN (public switched telephone network) to an interactive voice response system that is coupled to processing mechanism 132 (FIG. 1).

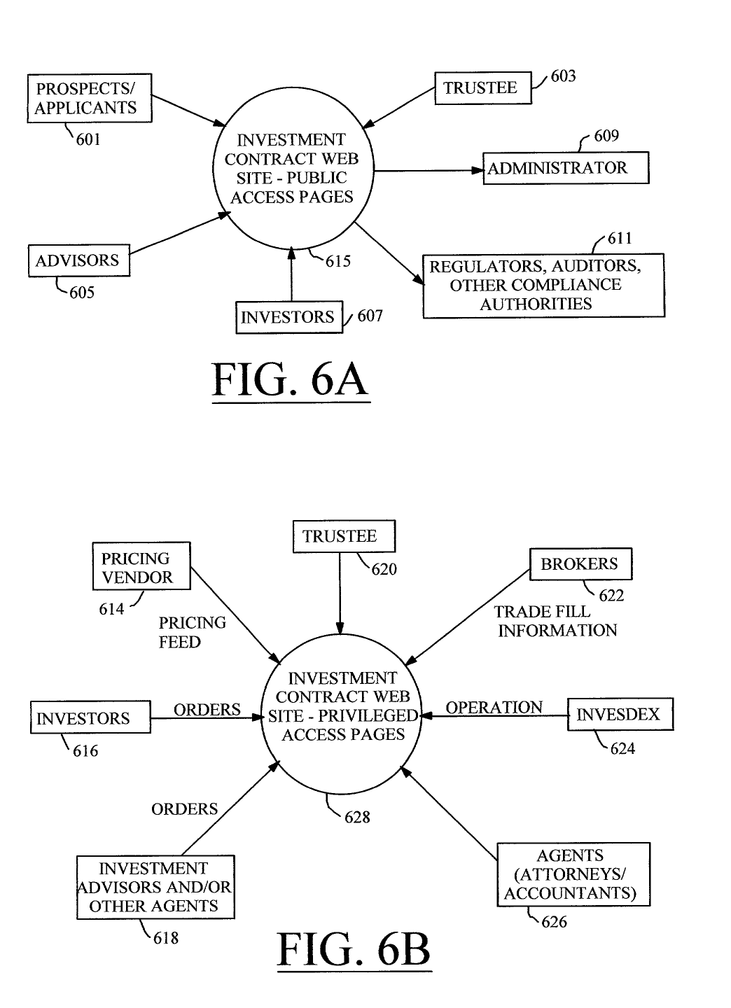

FIGS. 6A and 6B are information flow diagrams setting forth various types of data that may be received by, and/or transmitted to, the Investment Contract Web Site of FIG. 1. The Investment Contract Web Site may be programmed to provide a set of publicly accessible Web pages as well as a set of privately accessible Web pages. The publicly accessible Web pages are accessible from virtually any Internet-enabled endpoint device, whereas the privately accessible Web pages may only be accessed via passwords and/or via secure endpoint devices. The publicly accessible portion of the Web site is depicted in FIG. 6A as Investment Contract Web Site—Public Access Pages 615, and the privately accessible portion of the Web site is depicted in FIG. 6B as Investment Contract Web Site—Privileged Access Pages 628.

With respect to Public Access Pages 615, incoming information may be received from prospects/applicants 601, trustees 603, advisors 605, and investors 607. Outgoing information may be transmitted to entities such as administrators 609 and regulators, auditors, and other compliance authorities 611. The Privileged Access Pages 628 are accessed by pricing vendors 614, investors 616, investment advisors and/or other agents 618, trustees 620, brokers 622, other agents 626, and corporate entities such as Invesdex 624. Pricing vendors 614 input pricing feed information into the Web site. Investors 616 provide order information, and brokers 622 provide trade fill information. Advisors supply orders, and corporate entities such as Invesdex provide operational details. Agents 626 may include entities such as accountants and/or attorneys.

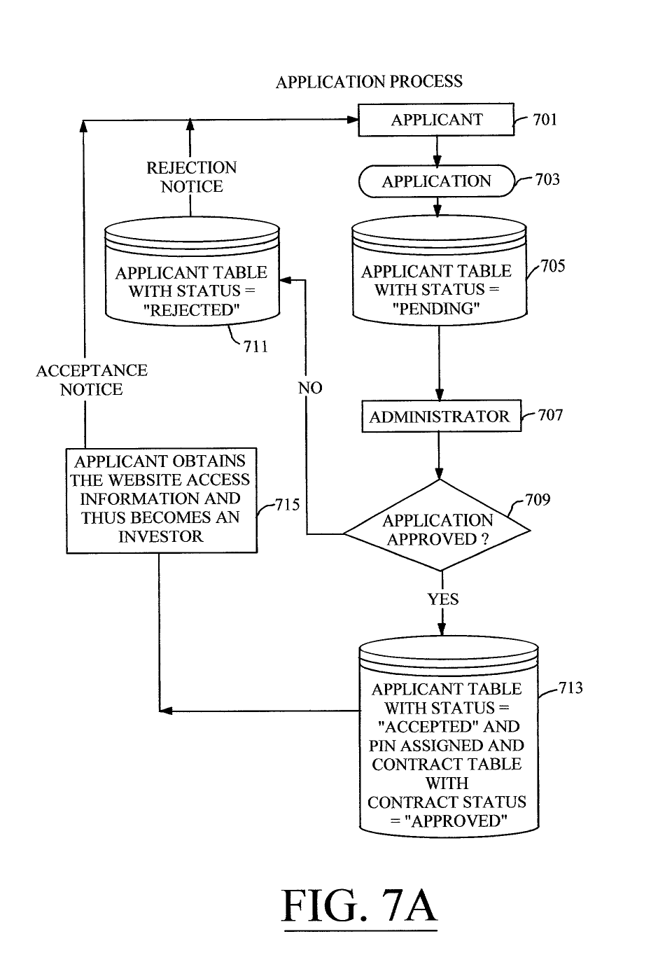

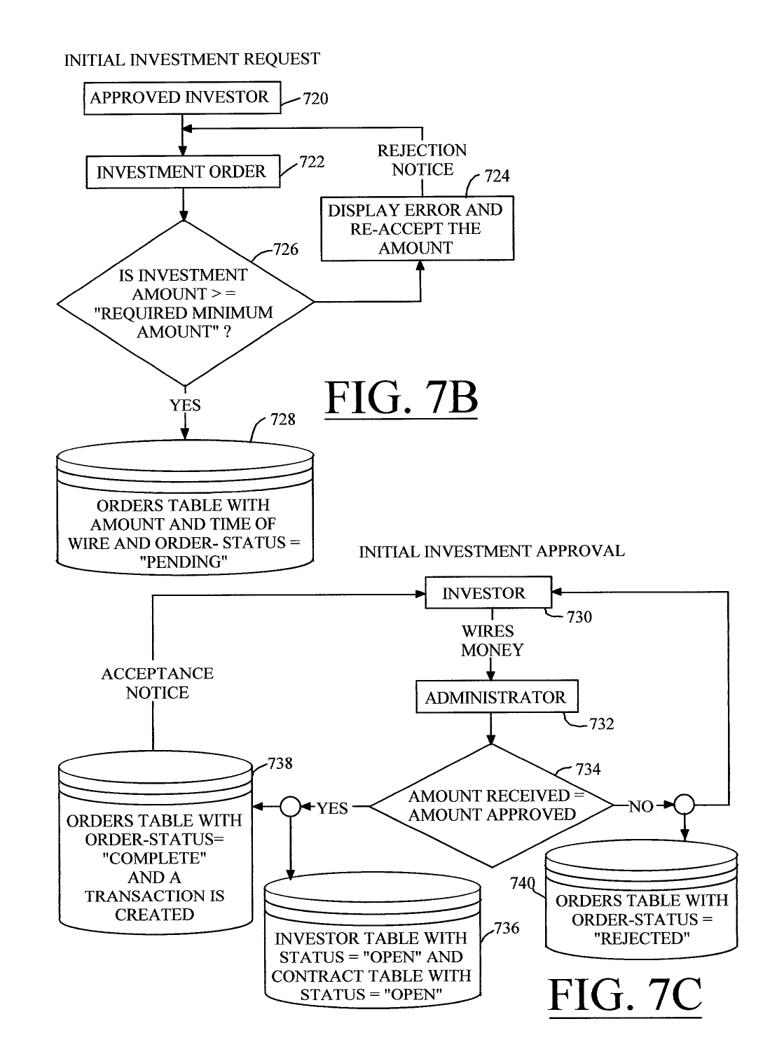

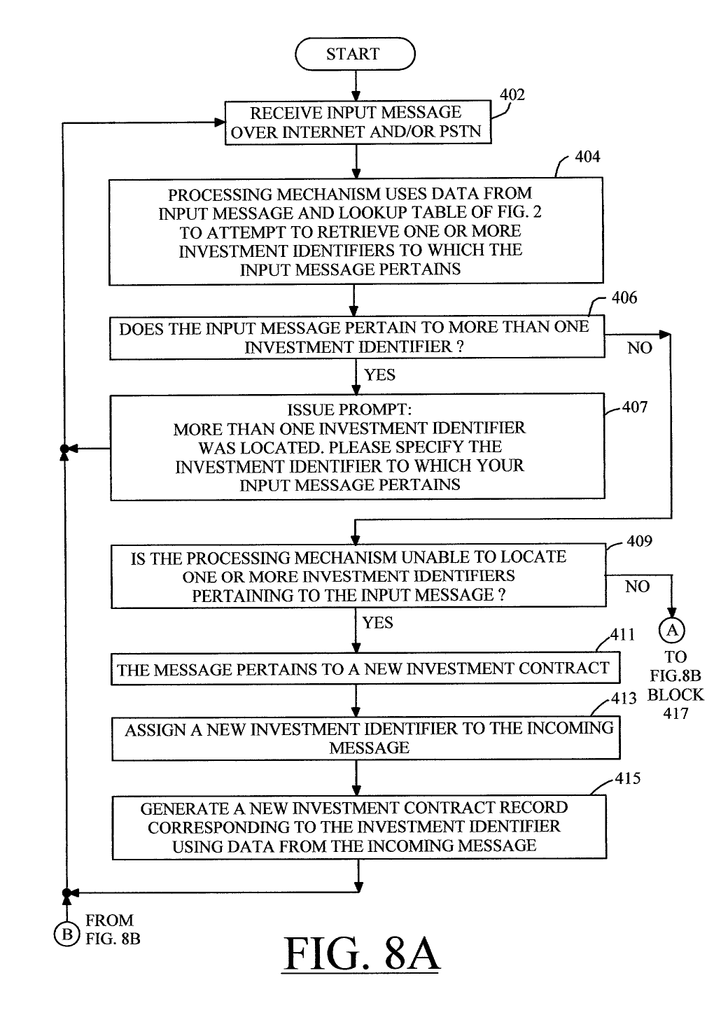

FIGS. 7A-7C are information flow diagrams setting forth the manner in which data are exchanged during the processes of accepting applications, receiving investment requests, and approving initial investments. During the application acceptance process (FIG. 7A), an applicant at block 701 (such as an individual investor) sends an electronic application (block 703) to the Investment Contract Web Site, whereupon the application is stored in an Applicant Table. Initially, the stored application is associated with a status flag set to “pending” (block 705). The pending electronic application is forwarded to an Administrator (block 707), which may be a bank or other financial institution. If the application is not approved (block 709), the status flag in the Applicant Table is set to “Rejected” (block 711). On the other hand, if the application is approved, the status flag in the Applicant Table is set to “Accepted”, and a PIN number is assigned to the applicant (block 713). A contract_status flag is set to “Approved”. This concludes information flow for the application acceptance process.

During the initial investment requesting process (FIG. 7B), an Approved Investor (block 720) sends an investment order (block 722) to the Investment Contract Web Site. If the investment amount is greater than or equal to the required minimum amount (block 726), then an Orders Table is populated with the amount and time of the fund transfer and an order_status flag is set to “Pending” (block 728). If the investment amount is less than the required amount, then an error message is sent to the Approved Investor (block 724), and the system accepts entry of a new amount from the Approved Investor.

With reference to FIG. 7C, the process of initial investment approval commences when an investor (block 730) wires or otherwise conveys money to the administrator (block 732). If the amount received equals the amount approved (as described in the context of FIG. 7B), then a status flag in an Investor Table is set to “Open”, and a status flag in a Contract Table is also set to “Open” (block 736). The previously mentioned order_status flag in the Orders Table is set to “Complete”, and a transaction is thereby created (block 738).

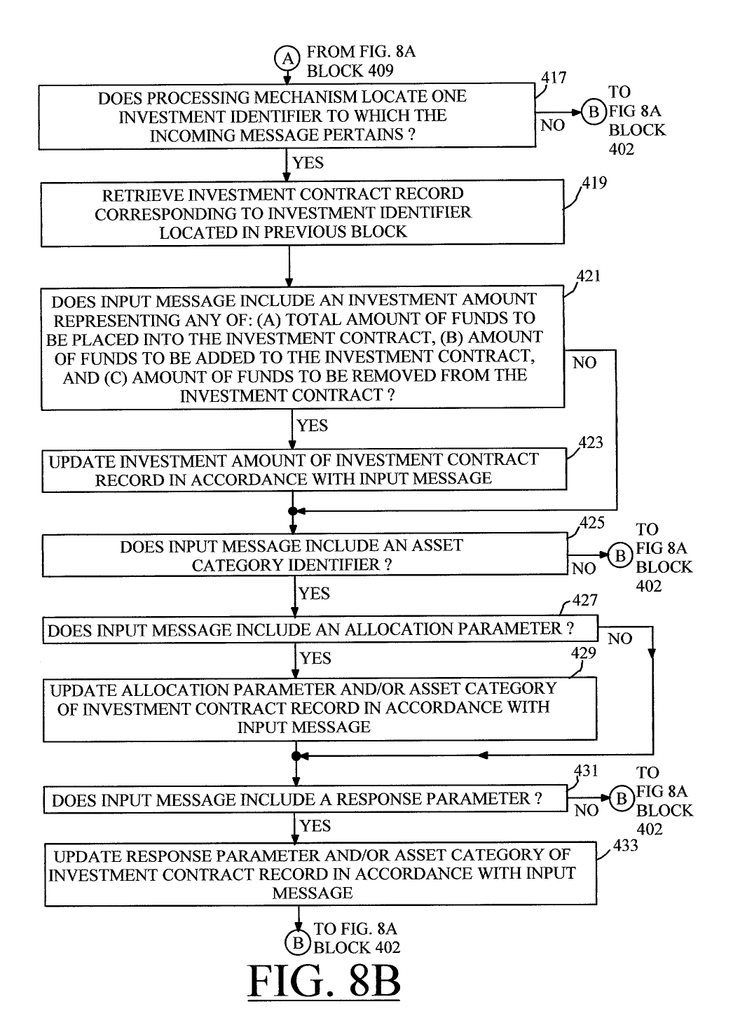

FIGS. 8A-8B together comprise a flowchart setting forth an operational sequence for generating and managing electronic investment contracts. At block 402, an input message is received over the Internet and/or over the Public Switched Telephone Network (PSTN) from an “Approved” Investor. Note that an investor's status as “approved” was previously determined at block 713 of FIG. 7A. The processing mechanism of the Investment Contract Web Site uses data from the input message and the lookup table of FIG. 2 to attempt to retrieve one or more investment identifiers to which the input message pertains (block 404). At block 406, a test is performed to ascertain whether or not the input message pertains to more than one identifier. If so, a prompt is issued: “More than one investment identifier was located. Please specify the investment identifier to which your input message pertains.” (block 407). The program then loops back to block 402.

The negative branch from block 406 leads to block 409 where a test is performed to determine whether or not the processing mechanism is unable to locate one or more investment identifiers pertaining to the input message. If not, the program jumps ahead to block 417, to be described in greater detail hereinafter. If so, the program progresses to block 411 where it is determined that the message pertains to a new electronic investment contract. A new investment identifier is assigned to the incoming message (block 413), and a new electronic investment contract record is generated, corresponding to the investment identifier, using data from the incoming message (block 415). The program then loops back to block 402.

Block 417 is reached from the negative branch of block 409. A test is performed to determine whether or not the processing mechanism is able to locate one investment identifier to which the message pertains. If not, the program loops back to block 402. If so, the program advances to block 419 where the electronic investment contract record corresponding to the investment identifier located in the previous block is retrieved. At block 421, a test is performed to ascertain whether or not the input message includes an investment amount representing any of: (a) total amount of finds to be placed into the electronic investment contract, (b) amount of funds to be added to the electronic investment contract, and (c) the amount of finds to be removed from the electronic investment contract. If such an input message is received, the investment amount of the investment contract record is updated in accordance with the input message (block 423).

Block 425 is reached from the negative branch of block 421, or after the operations of block 423 are performed. At block 425, a test is performed to determine whether or not the input message includes an asset category identifier. If not, the program loops back to block 402. If so, then another test is performed at block 427 to ascertain whether or not the input message includes an allocation parameter. If not, the program skips ahead to block 431. If so, then the allocation parameter and/or asset category of the electronic investment contract is updated in accordance with the input message.

Block 431 is reached from the negative branch of block 427, or after the operations of block 429 are performed. At block 431, a test is performed to determine whether or not the input message includes a response parameter. If so, the program advances to block 433 whereas, if not, the program loops back to block 402. At block 433, the response parameter and/or asset category of the electronic investment contract record is updated in accordance with the input message. The program then loops back to block 402.

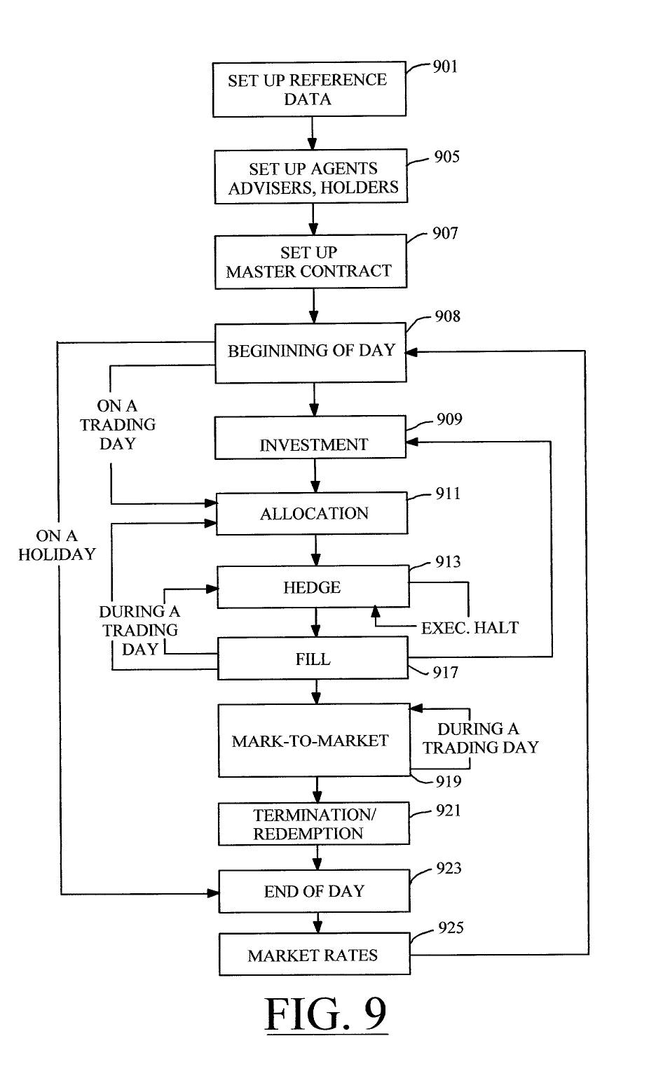

FIG. 9 is a flowchart setting forth a high-level operational sequence for managing electronic investment contracts. The procedure commences at block 901 where reference data are set up. Such data includes, for example, the Country/Asset Category/Exchange Table of FIGS. 4A and 4B, as well as trading times and holidays for the various exchanges, and a lookup table for various types of transactions. This lookup tables includes a plurality of transaction codes each specifying an order or type of investment, such as an investment, redemption, or an allocation. Each transaction code is associated with a corresponding description of the transaction. This setting up of reference data is performed upon initial launch of the Investment Contract Web Site, or at any subsequent point in time when it is desired to change one or more items of reference data. When an investor is ready to sign up for the Investment Contract Web Site, the program sets up information on advisors and/or other agents for this investor at block 905. Next, at block 907, a Master Contract is set up. This Master Contract represents a plurality of individual electronic investment contracts that an investment advisor will process as a group. Investor clients and/or individual contracts may be assigned to a group based upon the level of risk desired by that client and/or specified by that contract. The investment advisor then executes trades on behalf of the group, in view of the desired risk level.

At the beginning of every day (block 908), or at the beginning of another convenient defined time period, additional procedures are performed. At block 909, the client/investor wires, or otherwise conveys, investment funds to a custodian. After the receipt of funds is confirmed, the client/investor's contract balance is adjusted accordingly, and the program progresses to block 911 where an allocation procedure is performed. Based upon the allocation specified by the client/investor, this procedure generates a pending allocation order for the client/investor's contract.

Once a predetermined time is reached (a “trading time”), the program progresses to block 913. This trading time could be, for example, at the top of every hour or as frequently as every ten or fifteen minutes during days when one or more financial markets are open anywhere in the world. At block 913, all pending allocation orders for each asset category are “aggregated,” with buys offsetting “sells,” to determine a net buy or sell hedging order for each asset category. The hedging order for each asset category may, at the operator's discretion and/or automatically, be conveyed to a broker at block 917.

Orders conveyed to a broker are complete (filled) upon receiving a message (electronic or otherwise) from the broker indicating a confirmed amount and price for each order. For any order not conveyed to a broker, the program obtains a price from a data feed. For each asset category where the order is complete, the program establishes the asset price and gain/loss. If any order cannot be completed, it is included in the aggregation process the next time the program loops back to block 913.

The mark-to-market procedure of block 919 is performed after the aggregated order is filled, and is also performed prior to determining the hedging trade at each trading time. This step determines the market value of a contract at any time by applying current market prices to each market position. For example, in the case of a market position that initially specified $1400 in the S&P 500 Index, a financial calculation is performed to determine the gain or loss and current market value of this position with respect to the corresponding electronic investment contract.

The termination/redemption step of block 921 is only performed if the investor wishes to withdraw money from, or terminate, the electronic investment contract. At this point, the value of the contract is known because a mark-to-market value calculation has just been performed. Finally, at the end of every trading day (block 923), or at the beginning of a new trading day, new market rates are received. These market rates may include the U.S. Treasury Bill rate, the EUBOR rate, and/or the LIBOR rate, just to name a few illustrative examples.

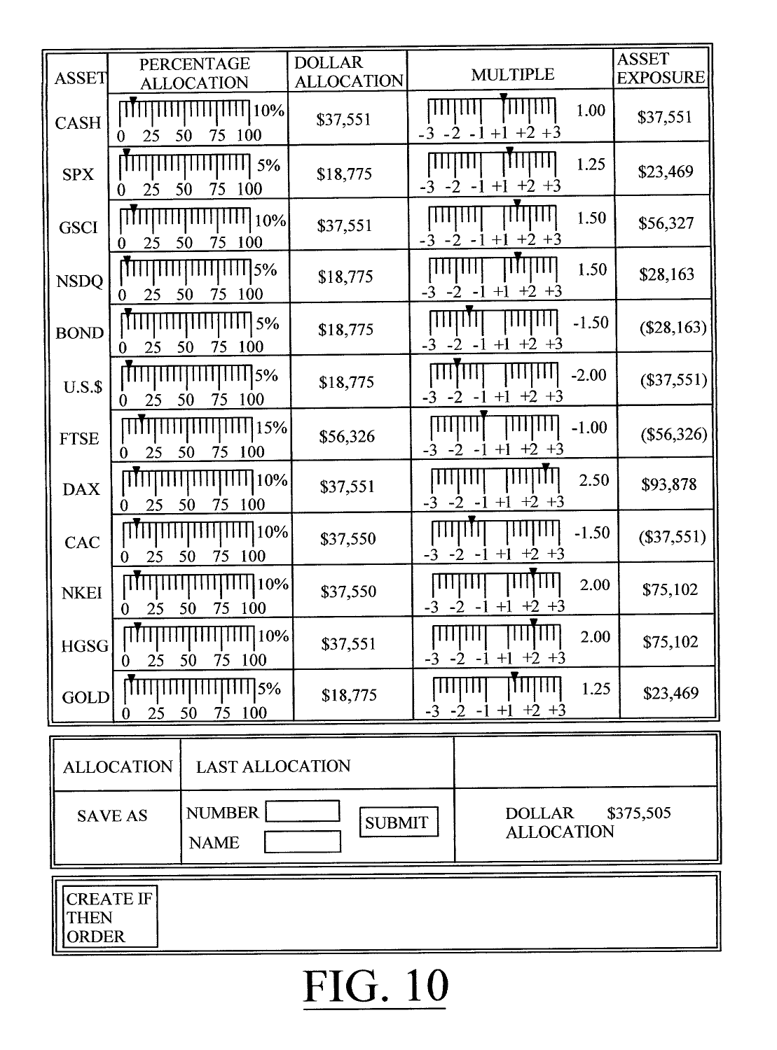

FIG. 10 is a screen-capture diagram showing an illustrative graphical user interface provided by the system of FIG. 1. Pursuant to a further embodiment of the invention, the electronic investment contracts are managed by means of an Internet-accessible graphical user interface. The user interface provides a mechanism by which each asset category of one or more electronic investment contracts can be maintained at a selected level of risk. The graphical user interface mechanism is coupled to a data processing mechanism that calculates an aggregate level of exposure to a given asset category among a plurality of electronic investment contracts. Based upon the aggregate exposure, the data processing mechanism establishes an aggregate position to be established by purchases or sales of individual securities, futures contracts in selected market indices, or other financial transactions related to that asset category. Electronic investment contract funds not required for the hedging process are invested in a mix of income-bearing instruments, such as U.S. Treasury Notes. As the investor changes the desired level of risk, or makes contract investments and/or contract redemptions, the data processing mechanism automatically adjusts the parameters related to their electronic investment contract, and automatically initiates any required market transaction in the relevant asset category. Based upon market prices, each electronic investment contract is updated in terms of exposure and net asset value. Optionally, an electronic investment contract administration fee may be charged.

According to a still further embodiment of the invention, the graphical user interface provides a conditional order entry mechanism adapted to accept conditional If-Then orders from an investor. The graphical user interface then forwards the conditional If-Then order to the data processing mechanism. The data processing mechanism responds to conditional If-Then investor requests such that, only upon the occurrence of the condition specified by the investor, a “template” is submitted as a pending allocation. This template is generated by the investor and inlcudes one or more asset category identifiers, allocation parameters, and/or response parameters pertaining to the investor's investment contract. The “template” is associated with the aforementioned conditional If-Then order. In this manner, the net position of the electronic investment contract reflects the asset category exposure and associated level of risk specified by the investor.

It will be readily seen by one of ordinary skill in the art that the present invention fulfills all of the objects set forth above. After reading the foregoing specification, one of ordinary skill will be able to effect various changes, substitutions of equivalents, and various other aspects of the invention as broadly disclosed herein. It is, therefore, intended that the protection granted herein be limited only by the definitions contained in the appended claims and equivalents thereof.

We claim:

1. A computerized method for generating an electronic investment contract, the method comprising the steps of:
associating each of one or more investment identifiers with an investment amount and one or more asset category identifiers; and
associating each of the one or more asset category identifiers with: (a) a corresponding allocation parameter, and (b) a corresponding response parameter;
wherein each of respective investment identifiers uniquely specifies a corresponding electronic investment contract;
wherein each of respective asset category identifiers uniquely specifies an investment asset category;
wherein the allocation parameter specifies an allocation amount to be indexed to the corresponding asset category identifier; and
wherein the response parameter specifies a relationship between (i) the allocation amount, and (ii) subsequent price, percentage return, and/or relative valuation changes in, and/or net worth changes relating to, the corresponding investment asset category.

2. The computerized method of claim 1 further including the step of generating a plurality of electronic investment contracts.

3. The computerized method of claim 1 further comprising the step of receiving an input enabling a determination of the investment identifier, and at least one of:
(a) the investment amount;
(b) the one or more asset category identifiers;
(c) the allocation parameter to be associated with each of the one or more asset category identifiers; and
(d) the response parameter to be associated with each of the one or more asset category identifiers.

4. The computerized method of claim 3 wherein a computing mechanism associates each of the one or more investment identifiers with the one or more corresponding asset category identifiers, and associates each of the one or more asset category identifiers with the corresponding allocation parameter and the corresponding response parameter, and wherein the input to the computing mechanism is received using at least one of:
(a) an electronic device coupled over the Internet to the computing mechanism; and
(b) a telephonic device coupled over the PSTN (public switched telephone network) to an IVR (interactive voice response) system and/or a speech recognition system, wherein the IVR and/or speech recognition system is coupled to the computing mechanism.

5. The computerized method of claim 3 wherein the step of receiving an input includes receiving one or more templates corresponding to a given investment identifier, each of respective templates setting forth a corresponding predefined allocation parameter and a corresponding predefined response parameter for each of one or more asset category identifiers.

6. The computerized method of claim 5 further including the steps of receiving a template selection, wherein the template selection uniquely specifies one of the received templates corresponding to the given investment identifier; and the template so selected is then applied to an electronic investment contract associated with the given investment identifier.

7. The computerized method of claim 5 further including the step of inputting a predefined condition to be associated with a specified one of the received templates, such that the specified one of the received templates is automatically applied to an electronic investment contract associated with the given investment identifier upon occurrence of the predefined condition.

8. The computerized method of claim 7 wherein the predefined condition is at least one of:
(a) an occurrence of: a specified price, percentage return, and/or relative valuation of, and/or change in net worth relating to, one or more investment asset categories;
(b) an occurrence of a specified date and/or time; and
(c) an occurrence of an event.

9. The method of claim 2 wherein each of one or more respective electronic investment contracts is held by a corresponding investor.

10. The method of claim 9 further including the step of determining an overall monetary value for each of the one or more respective electronic investment contracts.

11. The method of claim 10 wherein the electronic investment contract defines a financial relationship between a plurality of investors and a contract administrator such that, upon demand, the contract administrator shall convey the overall monetary value of the one or more respective electronic contracts held by a corresponding investor to that investor.

12. The method of claim 9 further including the step of calculating an aggregate position for an asset category by consolidating allocation parameters and response parameters associated with this asset category from a plurality of electronic investment contracts.

13. The method of claim 12 further including the steps of calculating aggregate positions for each of a plurality of asset categories.

14. The method of claim 13 further including the step of using the calculated aggregate positions to automatically generate purchase and/or sale orders for any of (a) futures contracts, (b) swaps, (c) contracts for differences, (d) securities, and (e) other financial instruments.

15. The method of claim 14 further including the steps of:
(a) determining an overall monetary value for each of the one or more respective electronic investment contracts, wherein the respective electronic investment contracts each define a financial relationship between a plurality of investors and a contract administrator such that, upon demand, the contract administrator has a payment obligation to convey the overall monetary value of the one or more respective electronic contracts held by a corresponding investor to that investor; and
(b) using the calculated aggregated positions to generate purchase and/or sales orders so as to enable the contract administrator to hedge the payment obligation.
